(19) United States
(12) Patent Application Publication
(10) Pub. No.: US 2021/0056610 A1
(43) Pub. Date: Feb. 25, 2021

(54) Building Customer Trust in Digital Financial Tools

(71) Applicant: Wells Fargo Bank, N.A., San Francisco, CA (US)

(72) Inventors: Gary F. Balding, Matthews, NC (US); Sharon B. Drawdy, Clyo, GA (US); Sunil Kothapalli, Marvin, NC (US); Adrienne Elizabeth Leo, Denver, NC (US); Danyall Lashon McDowell, Charlotte, NC (US); Daniel Sanford, Charlotte, NC (US); Brendon Hartman Treanor, Charlotte, NC (US)

(21) Appl. No.: 15/460,834

(22) Filed: Mar. 16, 2017

(51) Int. Cl. G06Q 30/06

(52) U.S. Cl. CPC G06Q 30/0631; G06Q 30/0613

(57) ABSTRACT

A method for a virtual digital assistant includes providing recommendations to a customer based on a level of trust the customer has with the virtual digital assistant. Preferences information is obtained regarding preferences of the customer regarding the virtual digital assistant. Technology comfort level information is obtained information regarding a comfort level of the customer with technology. The preferences information and the technology comfort level information are used to identify the level of trust the customer has with the virtual digital assistant. One or more recommendations are presented to the customer based on the level of trust.

### BACKGROUND

Individuals typically have various levels of comfort with digital technology. Some individuals, for example some older individuals, may not understand digital technology and may be uncomfortable using computers, cell phones and the Internet. Other individuals, for example younger individuals who grew up with computers, cell phones and other digital media, typically have a higher comfort level with digital and other technology.

Businesses typically provide online services to communicate with their customers and to provide marketing information and product offerings to their customers. However, because customers have differing comfort levels with technology, the businesses may be limited in the communications and offerings they can make to certain customers.

### SUMMARY

Embodiments of the disclosure are directed to a method for a virtual digital assistant that provides recommendations to a customer based on a level of trust the customer has with the virtual digital assistant, the method comprising: obtaining preferences information regarding preferences of the customer regarding the virtual digital assistant; obtaining technology comfort level information regarding a comfort level of the customer with technology; using the preferences information and the technology comfort level information to identify the level of trust the customer has with the virtual digital assistant; and presenting one or more recommendations to the customer based on the level of trust.

In another aspect, a method for a virtual digital assistant that provides recommendations to a customer of a financial institution comprises: receiving authorization from the customer to access customer financial account information at the financial institution; receiving authorization from the customer to access data regarding the customer from one or more social media sources; receiving information from the customer regarding customer preferences of how recommendations for the customer from the financial institution are presented and implemented when using the virtual digital assistant; receiving information from the customer regarding a comfort level of the customer with technology; receiving information regarding life events for the customer; and providing recommendations to the customer regarding products offered at the financial institution based on one or more of the life events and knowledge gained regarding the customer from the customer financial account information, the data regarding the customer from the one or more social media sources, the customer preferences and the comfort level of the customer with technology.

In yet another aspect, an electronic computing device comprises: a processing unit; and system memory, the system memory including instructions which, when executed by the processing unit, cause the electronic computing device to: obtain personal and financial information regarding the customer; obtain information regarding customer preferences; obtain information regarding the customer comfort level with technology; use the information regarding the customer preferences and the information regarding the customer comfort level with technology to identify a level of interaction for interactions between a virtual digital assistant and the customer; present one or more recommendations to the customer based on the level of interaction for the virtual digital assistant with the customer; identify a customer reaction to the one or more recommendations; and when the customer reaction is inconsistent with the level of interaction, adjust the level of interaction to be consistent with the customer reaction.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports building customer trust in digital financial tools.

FIG. 2 show example modules of the virtual digital assistant of FIG. 1.

FIG. 3 shows a method for building customer trust with a virtual digital assistant.

FIG. 4 shows another method for building customer trust with the virtual digital assistant.

FIG. 5 shows another method for customer interactions with the virtual digital assistant.

FIG. 6 shows example physical components of the financial institution server computer of FIG. 1.

### DETAILED DESCRIPTION

The present disclosure is directed to systems and methods for building customer trust in digital financial tools. Using the system and methods, a customer's level of trust with a digital financial tool is identified and interactions with the customer are based, in part, on the customer's level of trust with the digital financial tool. As the customer becomes more comfortable with technology, a business organization can provide more sophisticated interactions with the customer.

The systems and methods disclose a virtual digital assistant, an example digital financial tool that can interface with a customer. The virtual digital assistant can be provided by a business organization and can run on a digital device of the customer, such as a smartphone, a tablet computer, a laptop computer or a desktop computer. The business organization can obtain personal information regarding the customer, including customer preferences and the customer's comfort level and trust with technology. Based on the personal information, the virtual digital assistant can make recommendations to the customer for products offered by the business organization and for products and advice that can help the customer.

In this disclosure, the customer's level of trust with the virtual digital assistant represents a degree to which the customer feels comfortable using the virtual digital assistant. As discussed in more detail later herein, the customer's level of trust with the virtual digital assistant can be a combination of the customer's comfort level with technology and/or a specific attitude that the customer has regarding the virtual digital assistant.

In this disclosure, the business organization is described to be a financial institution, such as a bank, and the virtual digital assistant can provide financial advice to the customer and recommendations of product offerings from the financial institution. However, the systems and methods can also be used for other types of business organizations and for government organizations. Examples of business organizations can include department stores, consumer electronic stores and electronic commerce organizations such as Amazon. Examples of government organizations can include local government organizations that can provide services such as utility billing and information regarding classes and activities for local residents.

The systems and methods can also be used with other digital financial tools, including budgeting tools, investment tools, insurance tools, tax tools and retirement tools.

The systems and methods provide a way to help introduce the virtual digital assistant to individuals who may be less sophisticated with technology and who have a lower comfort level with technology. For these types of individuals, the virtual digital assistant can provide the product recommendations and advice in a non-threatening manner that can minimize a chance the customer would not be interested in using the virtual digital assistant. For example, the virtual digital assistant can provide a message informing the customer of an available product offering but not require or expect a response from the customer. When product offerings and advice are presented to the customer in a non-threatening way, the customer may become more comfortable with and begin to trust the virtual digital assistant more over time.

The financial organization may be able to detect, based on the customer's responses to the product offerings and advice, when the customer's trust level with the virtual digital assistant has increased. When the financial organization detects that the customer's trust level with the virtual digital assistant is increased, the virtual digital assistant can change a level of interaction with the customer. For example, the virtual digital assistant can learn of customer life events and provide product offerings and advise accordingly. As an example, if the financial institution learns that the customer is in the market for a vehicle, the virtual digital assistance can provide information to the customer regarding car loans that are available at the financial institution.

When the financial institution determines that the customer has become even more comfortable with the virtual digital assistant, with a possible pre-authorization from the customer, the virtual digital assistant can automatically implement one or more recommendations without first presenting the recommendations to the customer. For example, with a pre-authorization from the customer, the virtual digital assistant may be able to automatically use bill pay to pay a bill for the customer when the bill is due.

An example process for customer interactions with the virtual digital assistant using the systems and methods can comprise one or more of: 1) accessing the customer's comfort level with technology, 2) when a determination is made that the customer is not very comfortable with technology, not giving the customer full access to the capabilities of the virtual digital assistant, 3) gather activity and preferences data for the customer, 4) make low risk but helpful recommendations, 5) attempt to identify those recommendations that are most likely to be of interest to the customer, based on what is known about the customer, 6) report or track benefits that the customer obtained from the recommendations to help reinforce to the customer that the recommendations were helpful, and 7) progressively provide more sophisticated recommendations over time as the customer learns to trust the system and learns the value of the recommendations. More, fewer or different process steps are possible.

Using the systems and methods, the financial institution can obtain a personal profile of the customer including family and employment history. The financial institution can also access financial information regarding the customer such as bank accounts, personal loans and mortgages. The financial institution can also obtain life style information regarding the customer and determine a customer comfort level with technology. For example, the financial institution can provide the customer with a questionnaire that can determine how many and what types of computing devices the customer owns, whether the customer enjoys playing video games, how comfortable the customer is with others making financial decisions on their behalf, etc.

The financial institution can also obtain information from the customer regarding preferences using the virtual digital assistant. One preference can be an indication of how intrusive the virtual digital assistant can be. For example, recommendations and advice from the virtual digital assistant can include a mechanism, for example a drop-down menu arrow, that can permit the customer to respond to a recommendation and indicate that the customer does not want to see any more of these types of recommendations. Other preferences can indicate what type of products or services the customer is interested in viewing, how automated the customer wants the virtual digital assistant to be and to what degree the customer wants the virtual digital assistant to respond to life events. Other preferences are possible.

With customer permission, the financial institution can also obtain information regarding the customer from social media sources. Using the social media sources, the financial institution can obtain information regarding interests of the customer and can learn of life events regarding the customer. For example, using the social media sources, the financial institution can learn that the customer plans to marry, expects a child, desires to purchase a home, refinance a mortgage or take a specific vacation. Any information learned regarding the customer from social media and from other sources can permit the financial institution to provide recommendations and advice, via the virtual personal assistant, based on the information.

In addition, the virtual digital assistant can be integrated into customer activity at the financial institution. For example, when the customer is paying a bill using bill pay, the virtual digital assistant can display an alert message indicating that if the customer paid a certain amount toward a high-interest credit card, the customer could save a certain amount of money every year. As another example, when the customer is viewing checking account activity and the customer has a high balance in the checking account, the virtual digital assistance can display an alert message that the customer can use some of the checking account balance to purchase a specific investment. Other examples are possible.

The systems and methods disclosed herein are directed to a computer technology that can automatically build customer trust in digital financial tools. Information can be obtained from a number of sources regarding the customer's attitude towards technology. Based on the information a level of trust regarding a digital financial tool can be calculated. Based on the level of trust a financial institution can make recommendations to the customer regarding products available from the financial institution and regarding financial advice that may benefit the customer. Feedback can be obtained regarding the recommendations made to the customer and future recommendations can be adjusted based on the feedback.

The systems and methods can provide computing efficiencies at the financial institution in several ways. One way is that recommendations and financial advice can be specifically tailored to the customer, rather than sending common recommendations and advice to all customers. This can result in a greater likelihood that the recommendations and advice will be accepted and thereby improve the efficiency of computer operations at the financial institution. For example, the financial institution can be able to send out fewer recommendations and offers of financial advice. Another way is that by adjusting the recommendations and offers of financial advice based on customer feedback, there is a greater likelihood that the recommendations and offers will be accepted, thereby resulting in fewer communications to the customer and less wasted computer processing time.

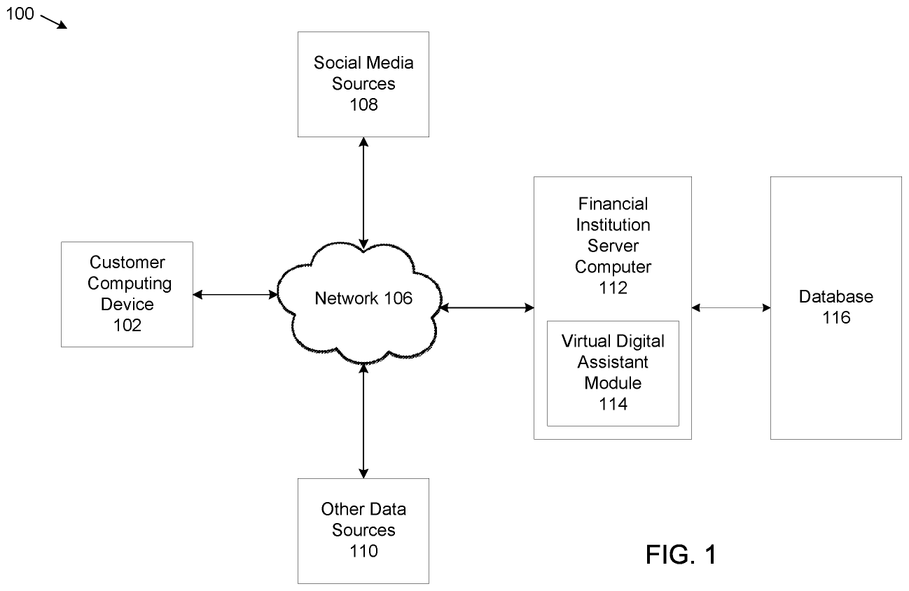

FIG. 1 shows an example system 100 that is programmed to build customer trust in digital financial tools. The example system 100 includes a customer computing device 102, a network 106, social media sources 108, other data sources 110, a financial institution server computer 112 and a database 116. Financial institution server computer 112 includes a virtual digital assistant module 114. More, fewer, or different components can be used.

The example customer computing device 102 is an electronic computing device such as a desktop computer, laptop computer, tablet computer or mobile computer, such as a smartphone. A customer of a financial institution associated with financial institution server computer 112 can use customer computing device 102 to access financial institution server computer 112 across network 106.

The example network 106 is a computer network such as the Internet. Customer computing device 102, social media sources 108 and other data sources 110 can wirelessly connect to or otherwise access financial institution server computer 112 via network 106.

The example social media sources 108 include social media sites such as Facebook, Twitter, LinkedIn and Instagram. Other social media sites can be used. With customer permissions, financial institution server computer 112 can access social media sources 108 to obtain information regarding the customer, as explained in more detail later herein.

The example other data sources 110 are websites external to financial institution server computer 112, that can provide financial and other information regarding the customer. Example other data sources 110 can include one or more financial aggregators that can provide updated financial information regarding the customer, financial organizations such as investment companies, real estate sources, business sources, government organizations, credit card companies and other organizations that can provide income, expenses and other information regarding the customer. Other data sources 110 are possible. For example local government organizations that can provide information regarding property taxes and home valuations and credit score companies that can provide a credit rating for the customer.

The example financial institution server computer 112 is a server computer of a financial institution at which the customer has one or more financial accounts. Financial institution server computer 112 contains or has access to financial records of the customer, including personal information and information regarding customer accounts. Financial institution server computer 112 also includes virtual digital assistant module 114.

The example virtual digital assistant module 114 can compile information about the customer that can be used to build customer trust in financial tools offered by the financial institution. The financial tools can include a virtual digital assistant that can be used to present the customer with recommendations and financial advice based on the customer trust. In this disclosure, the virtual digital assistant is a software application implemented on financial institution server computer 112.

The virtual digital assistant can receive messages sent to the customer from the financial institution, pop-up windows that can be rendered on customer computing device 102, interactive video sessions from an employee, such as a personal banker, of the financial institution that can be rendered on customer computing device 102 and other communications and actions from the financial institution that can provide financial assistance and product recommendations to the customer. The virtual digital assistant module 114 is discussed in more detail later herein.

The example database 116 is a database associated with the financial organization. Financial and other information regarding the customer can be stored in database 116.

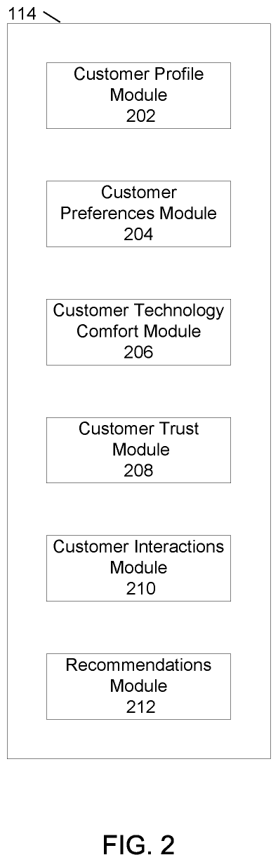

FIG. 2 shows example sub-modules of the virtual digital assistant module 114. The example virtual digital assistant module 114 includes a customer profile module 202, a customer preferences module 204, a customer technology comfort module 206, a customer trust module 208, a customer interactions module 210 and a recommendations module 212. More, fewer or different modules are possible.

The example customer profile module 202 compiles a profile of the customer including such items as name, age, education, marital status, family members and ages, customer's employer, customer's salary, spouse's employer, spouse's salary, whether the customer owns a home, value of the home, mortgage information such as an amount, interest rate and years remaining on the mortgage, vacation homes, financial accounts at the financial institution, financial accounts at other institutions, investments and other similar information. Other profile items are possible.

The example customer preferences module 204 compiles information regarding preferences of the customer regarding electronic interactions with the customer using the virtual digital assistant. Example preferences can include a type of communication the customer prefers, including text, email, pop-up windows, alert notifications, electronic chats, etc. Other preferences can include authorizations for the virtual digital assistant, such as authorizing or not-permitting the virtual digital assistant to automatically implement recommendations or financial advice, requiring the virtual digital assistant to ask permission from the customer before implementing a recommendation or financial advice or permitting the virtual assistant only to present recommendations and financial advice to the customer but not implement the recommendations and financial advice. Other customer preferences are possible.

The example customer technology comfort module 206 obtains information regarding the customer's comfort level with technology and compiles a technology comfort score that can be used to determine how the virtual digital assistant interacts with the customer. In an example implementation, the score can be a numerical value between 1 and 5 with 1 indicating very low comfort with technology and 5 indicating very high comfort with technology. Other ways to indicate the customer's comfort with technology are possible.

The customer technology comfort module 206 can assign a score to the customer based on evaluation of information regarding the customer's attitude towards technology, computers, smartphones and other electronic devices that the customer owns and known activities of the customer related to technology, such as whether the customer enjoys playing electronic games, whether the customer is a participant in social media and an extent of the participation, and whether the customer likes to purchase the latest electronic products, such as Amazon Echo. The customer technology comfort module 206 can assign the customer a technology comfort score (for example in a range of 1 to 5) based on the evaluation.

The customer technology comfort module 206 can calculate the technology comfort score based on metrics regarding the customer's attitude towards technology. Example metrics can be whether the customer uses email, an approximate number of email messages that the customer sends and receives in a day, whether the customer has a credit card, the number of credit cards the customer uses, whether the customer has a debit card, whether the customer uses bill pay, whether the customer has a credit line at a financial institution, whether the customer uses an automatic teller machine (ATM), whether the customer has a smartphone, whether the customer has a tablet computer, whether the customer uses wireless in the customer's home, whether and an extent to which the customer uses social media, whether the customer has an online brokerage account and whether the customer makes trades using an online brokerage account. Other metrics are possible. Examples of how these metrics can be obtained can include obtaining the metrics from customer account data at the financial institution, from questionnaires filled out by the customer and from interviews given by the customer to an employee of the financial institution. Other examples are possible.

In an example implementation, the customer technology comfort module 206 can check for certain metrics to assign different technology comfort scores. In the example implementation, when a determination is made that the customer does not have a credit card or an email account, the customer technology comfort module 206 can assign a technology comfort score of 1 to the customer. In the example implementation, when a determination is made that the customer has a credit card, an email account and a smartphone, the customer technology comfort module 206 can assign a technology comfort score of 2 to the customer.

In the example implementation, when a determination is made that the customer has a credit card, an email account, a smartphone and uses bill pay, the customer technology comfort module 206 can assign a technology comfort score of 3 to the customer. In the example implementation, when a determination is made that the customer has a credit card, an email account, a smart phone, uses bill pay, is an active user of social media and has an average daily volume of received and sent email messages above a certain threshold, the customer technology comfort module 206 can assign a technology comfort score of 4 to the customer. In the example implementation, when a determination is made that the customer has all the metrics mentioned for a technology comfort score of 4, makes extensive use of online electronic games and makes trades using the online brokerage account, the customer technology comfort module 206 can assign a technology comfort score of 5 to the customer. In other implementations, different metrics can be used to assign the technology comfort scores.

The example customer trust module 208 uses information from the customer profile module 202, the customer preferences module 204 and the customer technology comfort module 206 to determine a level of trust for the customer with the virtual personal assistant. The level of trust can be a numerical score that can be used to determine how the virtual digital assistant interacts with the customer. In an example implementation, the score can be a numerical value between 1 and 5 with 1 indicating a very low trust level and 5 indicating a very high trust level. Other scoring methods are possible. In some implementations, the score for the customer level of trust can be the same as for the customer comfort level with technology.

The customer trust module 208 can assign the numerical score for the level of trust based on an evaluation of a level of trust the customer is determined to have with using digital financial tools such as the virtual digital assistant. In some implementations, the numerical score assigned for the level of trust can correspond exactly to the numerical score assigned for the technology comfort score. In other implementations, when specific attitudes of the customer are known regarding virtual digital assistant, the numerical score assigned to the level of trust can be different than that assigned for the technology comfort score. For example, if the customer is assigned a technology comfort score of 2, but the customer has expressed interest in using a tool such as the digital virtual assistant, the customer trust module 208 can assign the customer a level of trust score of 3, instead of assigning the customer a level of trust score of 2. As another example, if the customer is assigned a technology comfort score of 4, but the customer has expressed an interest in permitting the virtual digital assistant to automatically implement as least some of recommendations and product advice, the customer trust module 208 can assign the customer a level of trust score of 4, instead of 3. Other examples are possible.

The example customer interactions module 210 determines a level of interaction for the virtual digital assistant when interacting with the customer. The customer interactions module 210 uses information from the customer profile module 202, the customer preferences module 204, the customer technology comfort module 206 and the customer trust module 208 to determine the level of interaction for the virtual digital assistant.

In an example implementation, the level of interaction can be a numerical score from 1 to 5. In the example implementation, a level of interaction of 1 can direct the virtual digital assistant to present generic recommendations to the customer but not implement any of the recommendations. In the example implementation, a level of interaction of 2 can direct the virtual digital assistant to present low risk recommendations based on an analysis of the customer's needs but not implement any of the recommendations. In the example implementation, a level of interaction of 3 can direct the virtual digital assistant to present moderate risk recommendations to the customer, based on an analysis of the customer's needs but not implement any of the recommendations. In the example implementation, a level of interaction of 4 can direct the virtual digital assistant to present recommendations and financial advice to the customer, request an authorization from the customer for each recommendation and item of financial advice and implement a recommendation and item of financial advice when authorization is received from the customer to implement the recommendation and item of financial advice. In some implementations, the authorization can be a biometric authorization, such as a thumbprint scan, retinal scan or facial scan of the customer.

In the example implementation, a level of interaction of 5 can direct the virtual digital assistant to automatically take an action when appropriate without requesting permission from the customer for each action. In the example implementation, when the customer permits a high level of interaction, such as a level of interaction of 5, the customer understands the type of actions the virtual digital assistant can take and provides a pre-authorization for any of these actions.

Example actions the virtual digital assistant may be able to take for a level of interaction of 5 can include determining that an amount in a checking account of the customer is too high (for example, higher than a limit previously set by the customer) and automatically transferring money from the checking account into a savings account or another investment previously specified by the customer. As another example of an action the virtual digital assistant may be able to take for a level of interaction of 5, the virtual digital assistant can determine that a bill, for example an electric bill, for the customer is due to be paid and automatically use bill pay at the financial institution to pay the bill. Other examples are possible.

The level of interaction can also be adjusted based on customer reactions to product recommendations and financial advice. A threshold can be used to determine when the level of interaction can be adjusted. For example, when the customer reacts in a negative way to a specific type of recommendation or advice and this negative reaction occurs for a plurality of similar recommendations that exceeds the threshold, the level of interaction can be decreased. Similarly, when the customer reacts in a positive way to a specific type of recommendation or advice and this occurs for a plurality of similar recommendations that exceeds the threshold, the level of interaction can be increased. In an example implementation, the threshold can be three, although other thresholds can be used.

In some implementations, one or more of the customer technology comfort module 206, the customer trust module 208 and the customer interactions module 210 can be combined. In these implementations, instead of having separate scores for the customer comfort with technology, level of trust and level of interaction, two or more scores can be combined. For example, in an implementation where the customer technology comfort module 206 and the customer trust module 208 are combined, the customer comfort with technology can be merged into the level of trust score. Similarly, when all three modules are combined, the customer comfort with technology and the level of trust can be merged into the level of interactions score or the customer comfort with technology and the level of interactions can be merged into the level of trust score. Other examples are possible.

When two or more of the customer technology comfort module 206, the customer trust module 208 and the customer interactions module 210 are merged, in an example implementation the scores from each module are added together and averaged to normalize the scores to the same range as for each module. The following formula provides an example of how the merged scores can be calculated when three modules are merged.

Merged score=(technology comfort score+level of trust score+level of interaction score)/3

In other implementations different weights can be applied to the scores of the modules. Each weight can be a fraction of 1, with all the weights adding up to 1. For example:

Merged score=((0.3*technology comfort score)+(0.3*level of trust score)+(0.4*level of interaction score)

Other examples are calculated merged scores are possible.

The example recommendations module 212 determines product recommendations and financial advice that may be appropriate for the customer and makes these product recommendations and financial advice available to the virtual digital assistant to present to the customer. The recommendations module 212 can use information from the customer profile module 202, from social media sources 108 and from other data sources 110 to determine what recommendations and financial advice may be relevant to the customer. For example, if the recommendations module 212 determines from social media sources 108 that the customer has or is expecting a new baby, the recommendations module 212 can provide product offerings regarding diapers or child care services to the customer.

The recommendations module 212 can also receive feedback from the customer to recommendations and financial advice made to the customer. When the feedback is negative, the recommendations module 212 can adjust future recommendations to the customer. The recommendations module can also provide the feedback to the customer preferences module 204 and the customer technology comfort module 206 so that customer preferences and comfort level with technology can be updated.

For example, when feedback is received that the customer does not want any to see any more recommendations similar to one currently being viewed by the customer, the recommendations module 212 can determine not to send any more such recommendations to the customer. For example, the customer may click on a user interface item such as an arrow or pull-down menu item indicating that the customer does not want to see any more similar recommendations.

The recommendations module 212 can also detect any changes of the customer trust level and comfort with technology and adjust customer preferences, technology comfort level, level of trust and level of interactions accordingly. For example, when the customer has a low comfort level of technology but the recommendations module 212 receives information from social media sources indicates that the customer has become more comfortable with technology, the recommendations module 212 can send this information to the customer technology comfort module 206 and the customer technology comfort module 206 can increase the comfort level with technology score for the customer.

In addition, depending on the magnitude of the increase in the comfort level, one or both of the customer trust module 208 and the customer interactions module 210 can increase the level of trust score and the level of interactions score, respectively. Examples of information regarding the customer comfort level with technology can include social media posts indicating that the customer has purchased certain types of electronic equipment, has become a computer gamer or even has joined a social media site when the customer had not participated in social media before. Other examples are possible.

The recommendations module 212 can also obtain feedback from the customer that can result in a change of customer preferences. For example, when the recommendations module 212 provides a product recommendation to which the customer reacts negatively, the recommendations module 212 can make an adjustment in customer preferences so that a type of the product recommendation is not sent to the customer again. As another example, when the customer reacts negatively to a certain method of communication, for example to an unsolicited electronic chat or video from a personal banker, the recommendations module 212 can notify the customer preferences module 204 to change the customer preferences accordingly. Other examples are possible.

The recommendations module 212 can provide recommendations of different degrees of sophistication. The recommendations can change from less sophisticated to more sophisticated depending on changes in the level of trust the customer has with the virtual digital assistant.

Example recommendations in an order from a low degree of sophistication to a higher degree of sophistication can include: 1) presenting generic recommendations of banking products to the customer without requiring a response from the customer. An example of a generic recommendation can be an offer of a car loan at a low interest rate; 2) presenting a recommendation of banking products based on an analysis of the customer's personal and financial information that involves low risk to the customer. An example of a low risk recommendation based on an analysis of the customer's needs can include an offer to apply for a bank credit card and a recommendation for a vacation trip to a destination known to be of interest to the customer; 3) presenting a recommendations of banking products based on an analysis of the customer's personal and financial information that involves moderate risk to the customer. An example of a moderate risk recommendation can include a recommendation to apply for bill pay or an offer for the customer to apply for a line of credit; 4) presenting recommendations for an automatic financial operation of the financial institution, but requiring a specific authorization from the customer before implementing a recommendation.

An example of implementing a recommendation after a specific authorization from the customer can comprise an offer to pay a specific customer bill using bill pay when the bill becomes due. Other examples can be to transfer funds from a checking account to a money market account and to open a Roth IRA account and transfer customer funds from the customer's conventional IRA account to the Roth IRA account; and 5) presenting recommendations that can be automatically implemented by the financial institution with a pre-authorization from the user. An example would be to permit the financial institution to automatically pay a bill using bill pay when the bill becomes due. Other degrees of sophistication in recommendations are possible.

Capabilities of the virtual digital assistant can change for different levels of intervention and when recommendations of different levels of sophistication are implemented. The capabilities can change based on changes to level of trust for the customer. In one implementation, each level of sophistication can correspond to a level of trust. For example, when the level of trust is 1, virtual digital assistant can provide recommendations at the degree of sophistication described by 1) above. Similarly, when the level of trust is 2, 3, 4 and 5, respectively, the virtual digital assistant can provide recommendations at the degree of sophistication described by 2), 3), 4) and 5), respectively. Other implementations are possible.

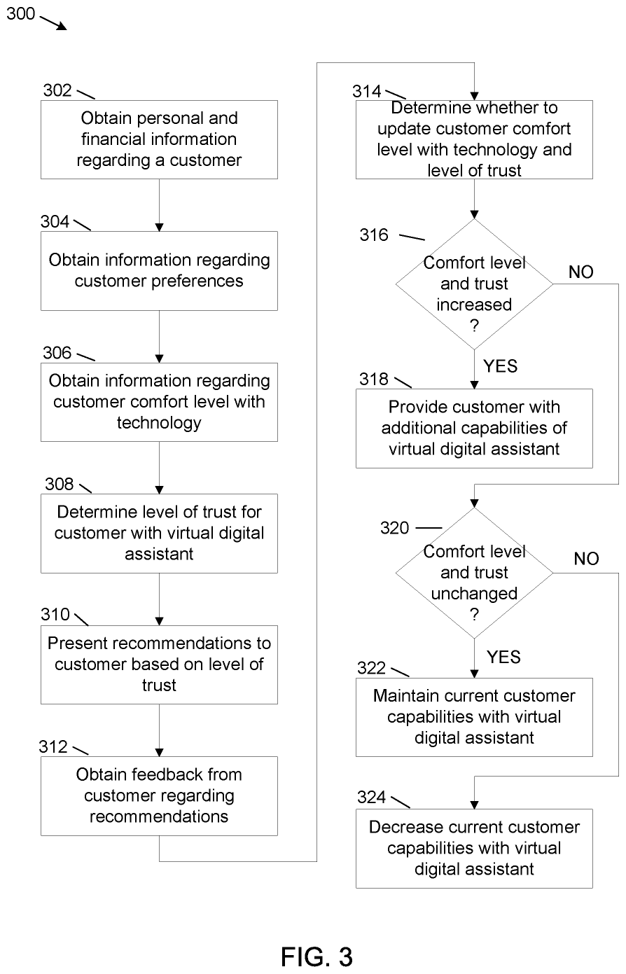

FIG. 3 shows a flowchart of an example method 300 for building customer trust with a virtual digital assistant. For method 300, the financial tool is a virtual digital assistant that is implemented as a software application on financial institution server computer 112.

At operation 302, personal and financial information regarding a customer is obtained. The personal and financial information can be obtained from one or more of financial institution server computer 112, database 116 and other data sources 110. The personal information can be obtained from a profile of the customer compiled by the financial institution, from customer financial account information available at the financial institution and from financial information regarding the customer from other sources, such as financial aggregators.

At operation 304, information is obtained regarding customer preferences regarding customer interactions using the virtual digital assistant. As discussed earlier herein, the customer preferences can include a type of communication the customer prefers including text, email, pop-up windows, alert notifications, electronic chats, etc. The customer preferences can also include authorizations for the virtual digital assistant, such as authorizing or not-permitting the virtual digital assistant to automatically implement recommendations or financial advice, requiring the virtual digital assistant to ask permission from the customer before implementing a recommendation or financial advice or permitting the virtual assistant only to present recommendations and financial advice to the customer but not implement the recommendations and financial advice. Other customer preferences are possible. The customer can communicate the customer preferences to the financial institution in one of several ways, such as via a website of the financial institution, via a meeting with an employee, such as a personal banker, of the financial institution, via email and via a completed questionnaire mailed to the financial institution. Other ways to communicate the customer preferences to the financial institution are possible.

At operation 306, information is obtained regarding a comfort level the customer has with technology. The information regarding the comfort level can be obtained in one of several ways, including, but not being limited to, a conversation with the customer, having the customer fill out one or more questionnaires or surveys, via observation of the customer's interactions with the financial institution and from social media sources. For example, information that the customer is on social media can indicate that the customer uses social media applications and has is comfortable with technology regarding social media. Information that the customer enjoys playing video games can suggest a high comfort level with technology. Information that the customer does not have a smartphone and only recently started to use a desktop computer can suggest a low comfort level with technology. Other examples are possible.

At operation 308, a level of trust for the customer with the virtual digital assistant is determined. The level of trust is determined by evaluating the information obtained at operation 306 regarding the comfort level the customer has with technology. For method 300, the level of trust is a numerical score having a value of 1 to 5, where 1 represents a low level of trust and 5 represents a high level of trust.

At operation 310, one or more recommendations are presented to the customer by the financial institution based on the level of trust. The recommendations can include products for which the customer may have an interest, based on knowledge the financial institution has regarding the customer. The recommendations can also include financial advice provided by the financial institution based on knowledge the financial institution has regarding the customer. When the customer is determined to have a low level of trust with the virtual digital assistant, the recommendations can be simple and non-threatening such as a message describing a product offered by the financial institution that may be of interest to the customer. Conversely, when the customer has a high level of trust with the virtual digital assistant, the recommendations can be more sophisticated, such as suggesting the customer start using bill pay or suggesting a specific investment opportunity for the customer.

At operation 312, feedback is obtained from the customer regarding the recommendations of operation 310. The feedback can include comments provided by the customer. The feedback can also include customer reactions to the recommendations. For example, if the customer takes a positive action regarding a recommendation, such as expressing interest in or purchasing a recommended product or in implementing a suggestion of financial advice, such as initiating and using bill pay, the feedback can indicate that the customer is happy with the recommendations and that the level of trust established for the customer is correct or may be increased. Conversely, if the customer ignores the recommendations or specifically indicates not to provide any more of such recommendations, the feedback can indicate that is customer is uncomfortable with the recommendations and that the level of trust for the customer may be too high and can be lowered.

At operation 314, based on the feedback from the customer, a determination can be make whether to update the customer's comfort level with technology and the customer's level of trust with the virtual digital assistant.

At operation 316, when a determination is made that the comfort level with technology and the customer's level of trust with the virtual digital assistant has increased, at operation 318, the customer is provided with additional capabilities of the virtual digital assistant. The additional capabilities can include providing more sophisticated recommendations and financial advice. The additional capabilities can also include having the virtual digital assistant automatically implementing a recommendation. As an example of providing more sophisticated recommendations and automatically implementing one or more of the recommendations, the virtual digital assistant can determine, based on guidelines established by the customer, that the customer has too high a balance in a checking account. The virtual digital assistant can then automatically transfer a specific amount of money from the checking account to a savings account or money market fund for the customer. The specific amount of money transferred can also be based on guidelines established by the customer. Other examples are possible.

At operation 316, when a determination is made that the comfort level with technology and the customer's level of trust with the virtual digital assistant has not increased, at operation 320, a determination is made as to whether the customer's level of trust with the virtual digital assistant is unchanged.

At operation 320, when a determination is made that the customer's level of trust with the virtual digital assistant is unchanged, at operation 322, the current customer capabilities with the virtual digital assistant are maintained.

At operation 324, when a determination is made that the customer's level of trust with the virtual digital assistant has decreased, at operation 324, the current customer capabilities with the virtual digital assistant are decreased. An example of decreasing the customer capabilities can be to provide recommendations to the customer but not to automatically implement the recommendations. Another example can be to decrease the level of sophistication of the recommendations, perhaps to just provide information regarding available products and not provide any financial advice.

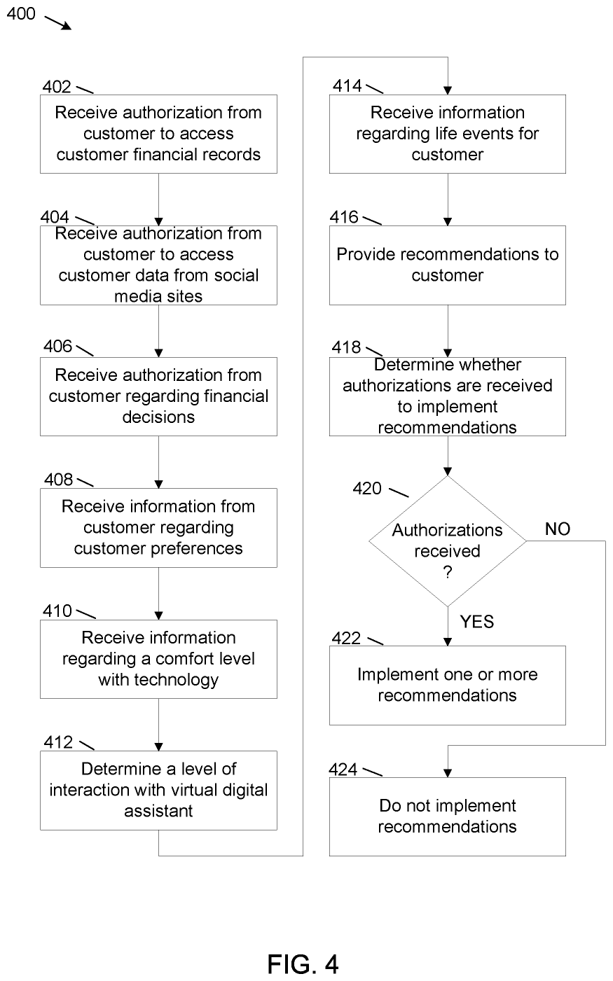

FIG. 4 shows a flowchart of another example method 400 for building customer trust with the virtual digital assistant. For method 400, the financial tool is a virtual digital assistant that is implemented as a software application on financial institution server computer 112.

At operation 402, authorization is received from the customer to access customer financial records. The authorization can be for customer financial records accessible at or by the financial institution. The authorization can also be for customer financial records or information accessible elsewhere, for example from other data sources 110. For example, information from other data sources 110 can include information from financial aggregators.

At operation 404, authorization is received from the customer to access customer data from social media sites. For example, the authorization can permit the financial institution to access social media news feeds or other social media data regarding the customer.

At operation 406, authorization is received from the customer regarding financial decisions. For example, the customer can authorize the financial institution to automatically implement some types of recommendations or financial advice. The customer can also specifically not authorize automatic implementation of recommendations or financial advice.

At operation 408, information is received from the customer regarding customer preferences. In addition to the customer preferences discussed earlier herein, the customer can provide specific information regarding automatic implementations of recommendations and advice, such as specific types of recommendations and advice that can be automatically implemented and specific dollar amount thresholds that can be used when implementing the recommendations and advice. For example, the customer can specify a dollar amount in a checking account that when exceeded can result in an automatic transfer of funds from the checking account to a money market account. The customer can also specific an amount of funds that can be transferred.

At operation 410, information is received regarding a comfort level of the customer with technology. The information can be received in one or more of several ways, including during an interview with an employee of the financial institution, via a questionnaire that can be filled out by the customer and via data regarding habits, interests and activities of the customer that can be obtained from social media sources.

At operation 412, a level of interaction with the virtual digital assistant is determined. The level of interaction determines an extent to which the virtual digital assistant interacts with the customer. The extent can range from 1) providing informational notices of products and services from the financial institution that may be of interest to the customer to 2) providing recommendations on products and services from the financial institution and other products and services that may be of interest to the customer and also providing financial advice to the customer to 3) providing the information in 2) plus automatically implementing one or more of the product recommendations or financial advice. Other interactions are possible.

The level of interaction is determined from the information received at operation 408 regarding customer preferences and from the information received at operation 410 regarding the comfort level of the customer with technology. For method 400, a level of trust score is calculated from the information regarding the customer preferences and the information regarding the comfort level of the customer with technology. For method 400, the level of interaction is determined from the level of trust score. In some implementations, a level of interaction can correspond directly to a level of trust score. For example, a level of interaction of 1 can correspond to a level of trust score of 1, a level of interaction of 3 can correspond to a level of trust score of 3 and a level of interaction of 5 can correspond to a level of trust score of 5. In other implementations, the level of interaction and the level of trust score can be different.

At operation 414, information is received regarding life events for the customer. The information regarding life events can include information such as a marriage, a divorce, a birth of a child, a change in employment, a salary increase, a bonus, the purchase of a home, the purchase of electronic equipment, an expressed interest in one or more areas, such as video games, and other information. The information regarding life events can be received from social media sources and from information provided to the financial institution by the customer. The information regarding life events can be provided directly to the financial institution during an interaction with an employee of the financial institution, via email and via the website of the financial institution.

At operation 416, the financial institution provides one or more recommendations to the customer. Depending on the level of interaction, the recommendations an include product information, financial advice or a combination of product information and financial advice.

At operation 418, a determination is made as to whether the authorizations are received to implement one or more of the recommendations. The customer can provide one or more authorizations at operation 406.

At operation 420, when a determination is made that the customer has authorized implementing one or more of the recommendations, at operation 422, the one or more of the authorizations are implemented.

At operation 420, when a determination is made that the customer has not authorized implementation of any of the recommendations, at operation 422, the recommendations are not implemented.

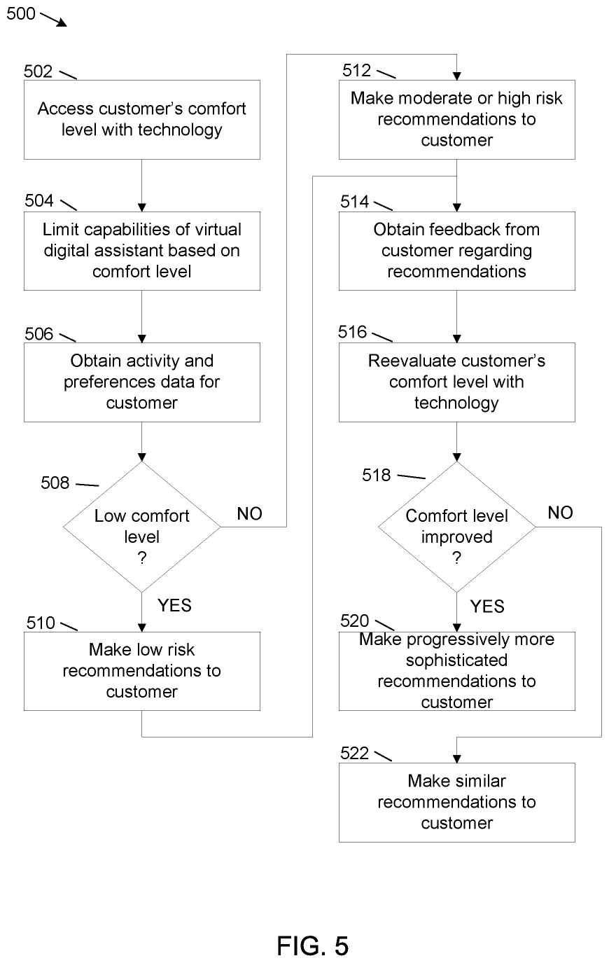

FIG. 5 shows a flowchart of a method 500 for a process for customer interactions with the virtual digital assistant. The flowchart of method 500 is based on the process for using the systems and methods described earlier herein.

At operation 502, the customer's comfort level with technology is assessed. As discussed earlier herein, the customer's comfort level with technology can be assessed by questionnaire, personal interview, social media and by obtaining feedback from customer reactions to recommendations presented to the customer.

At operation 504, the capabilities of the virtual digital assistant are limited based on the customer's comfort level with technology. As discussed earlier herein, the customer's comfort level with technology can determine a level of trust score for the customer with the virtual digital assistant and a level of interaction between the virtual digital assistant and the customer.

At operation 506, activity and preferences data are obtained from the customer. As discussed earlier herein, the preferences data can be obtained via interactions between the customer and the financial institution. The activity data can be obtained by direct input from the customer and from social media sites.

At operation 508, a determination is made as to whether the customer has low comfort level with technology.

At operation 508, when a determination is made that the customer has a low comfort level with technology, at operation 510, low risk recommendations are made to the customer.

At operation 508, when a determination is made that the customer does not have a low comfort level with technology, at operation 512, the virtual digital assistant provide moderate or high risk recommendations to the customer. As discussed earlier herein, a moderate recommendation can be a recommendation that is more sophisticated than a low risk recommendation, such as a recommendation to apply for bill pay or a recommendation that includes financial advice. Also, as discussed earlier herein, a high risk recommendation can include a suggestion to permit an automatic implementation of one or more recommendation.

At operation 514, feedback is obtained from the customer regarding the recommendations. The feedback can include a specific communication from the customer, for example to provide more such recommendations or not to provide any more such recommendations. The feedback can also be obtained by monitoring a reaction to the customer to the product recommendations. If the customer does not act on any of the recommendations over a period of time, an assumption can be made that the recommendations are not suited for the customer or that the customer has less trust in the virtual digital assistant than previously assumed. Conversely, if the customer does take an action such as purchasing a product based on the recommendation or signing up for a recommended product or service, such as bill pay, an assumption can be made that the customer likes the recommendations or has more of a trust in the virtual digital assistant.

At operation 516, the virtual digital assistant module 114 reevaluates the customer's comfort level with technology based on the feedback provided by the customer.

At operation 518, a determination is made as to whether the customer's comfort level with technology has improved.

When a determination is made at operation 518 that the customer's comfort level with technology has improved, at operation 520, the virtual digital assistant make progressively more sophisticated recommendations to the customer, as discussed earlier herein.

When a determination is made at operation 518 that the customer's comfort level with technology has not improved, at operation 522, the virtual digital assistant continues to make similar recommendations to the customer.

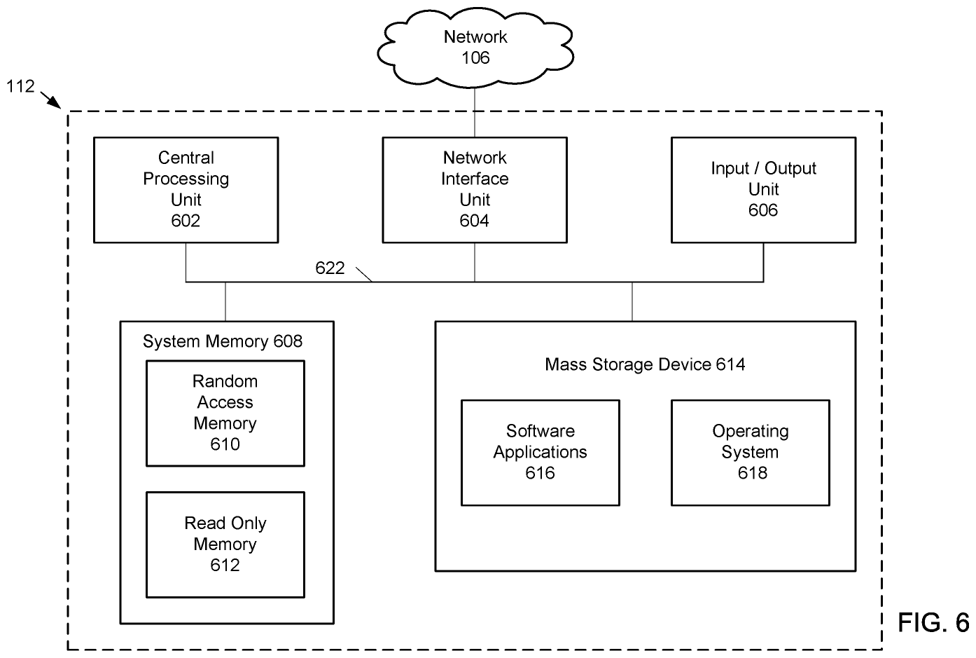

As illustrated in the example of FIG. 6, financial institution server computer 112 includes at least one central processing unit (“CPU”) 602, also referred to as a processor, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the financial institution server computer 112, such as during startup, is stored in the ROM 612. The financial institution server computer 112 further includes a mass storage device 614. The mass storage device 614 is able to store software instructions and data. Some or all of the components of the financial institution server computer 112 can also be included in customer computing device 102.

The mass storage device 614 is connected to the CPU 602 through a mass storage controller (not shown) connected to the system bus 622. The mass storage device 614 and its associated computer-readable data storage media provide non-volatile, non-transitory storage for the financial institution server computer 112. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computer 112.

According to various embodiments of the invention, the financial institution server computer 112 may operate in a networked environment using logical connections to remote network devices through the network 106, such as a wireless network, the Internet, or another type of network. The financial institution server computer 112 may connect to the network 106 through a network interface unit 604 connected to the system bus 622. It should be appreciated that the network interface unit 604 may also be utilized to connect to other types of networks and remote computing systems. The financial institution server computer 112 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the financial institution server computer 112 can store software instructions and data. The software instructions include an operating system 618 suitable for controlling the operation of the financial institution server computer 112. The mass storage device 614 and/or the RAM 610 also store software instructions and software applications 616, that when executed by the CPU 602, cause the financial institution server computer 112 to provide the functionality of the financial institution server computer 112 discussed in this document. For example, the mass storage device 614 and/or the RAM 610 can store software instructions that, when executed by the CPU 602, cause the financial institution server computer 112 to display received data on the display screen of the financial institution server computer 112.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for a virtual digital assistant that provides recommendations to a customer based on a level of trust the customer has with the virtual digital assistant, the method comprising:
obtaining, by the virtual digital assistant, technology comfort level information for the customer, the virtual digital assistant including a software application on a server computer, the obtaining including receiving, by the software application, an interactive video session between the customer and an employee of a financial institution, the video session being rendered on a computing device of one or more customer computing devices, the virtual digital assistant obtaining the technology comfort level information from the received interactive video session, the technology comfort level information including preferences information regarding preferences of the customer between different types of electronic interactions with the virtual digital assistant and including preferences of the customer for permitting or not permitting the virtual digital assistant to automatically implement one or more recommendations or financial advice;
obtaining, by the server computer, from one or more social media sites, additional technology comfort level information, the additional technology comfort information including one or more activities performed by the customer on the one or more social media sites using the one or more customer computing devices;
using the preferences information and the additional technology comfort level information including the detected one or more activities performed using the one or more customer computing devices to identify the level of trust the customer has with the virtual digital assistant; and
assigning a risk value to each of a plurality of recommendations;
selecting one of the recommendations based on the corresponding risk value and the level of trust;
presenting, using one of the one or more customer computing devices, at least the selected recommendation to the customer, and
if, based on the preferences information, the selected recommendation was authorized to be automatically implemented, automatically implementing, by the server computer, the selected recommendation.

2. The method of claim 1, further comprising:
obtaining feedback from the customer regarding at least the selected recommendation;
based on the feedback, updating the level of trust the customer has with the virtual digital assistant; and
when a determination is made that the level of trust the customer has with the virtual digital assistant has increased, providing the customer with additional capabilities of the virtual digital assistant.

3. (canceled)

4. The method of claim 1, further comprising:
notifying the customer that one or more of the plurality of recommendations are ready to be implemented; and
receiving an authorization from the customer to proceed with implementing the one or more of the plurality of recommendations.

5. The method of claim 1, further comprising obtaining personal information and financial information regarding the customer.

6. The method of claim 1, further comprising:
determining a level of interaction between the virtual digital assistant and the customer based on the level of trust;
identifying a customer reaction to at least the selected recommendation; and
when the customer reaction is inconsistent with the level of interaction, making a determination whether to adjust the level of interaction to be consistent with the customer reaction.

7. The method of claim 6, wherein making a determination as to whether to adjust the level of interaction to be consistent with the customer reaction comprises:
determining whether the customer reaction to the selected recommendation is similar to previous customer reactions for the selected recommendation; and
when a number of similar customer reactions for the selected recommendation is greater than a threshold, adjust the level of interaction to be consistent with the customer reaction.

8. The method of claim 7, wherein when the number of similar customer reactions for the selected recommendation is greater than the threshold, further comprising adjusting customer preferences to be consistent with the customer reactions.

9. The method of claim 1, wherein presenting at least the selected recommendation to the customer comprises a first level of interaction with the customer corresponding to a first trust level.

10. The method of claim 9,
wherein implementing at least the selected recommendation comprises a second level of interaction with the customer corresponding to a second trust level.

11. The method of claim 1, further comprising obtaining feedback of customer reactions regarding at least the selected recommendation and automatically updating one or more of the preferences of the customer, the technology comfort level information, and the level of trust based on the customer reactions.

12. The method of claim 1, further comprising:
obtaining information regarding life events for the customer; and
modifying at least the selected recommendation presented to the customer based on one or more of the life events.

13. The method of claim 1, further comprising:
receiving feedback from the customer regarding a reaction of the customer to at least the selected recommendation presented to the customer; and
adjusting future recommendations for the customer based on the feedback.

14. A method for a virtual digital assistant that provides recommendations to a customer of a financial institution, the method comprising:
receiving authorization from the customer to access customer financial account information at the financial institution;
receiving authorization from the customer to access data regarding the customer from one or more social media sites;
receiving by the virtual digital assistant, technology comfort level information for the customer, the virtual digital assistant including a software application on a server computer, the receiving including receiving, by the software application, an interactive video session between the customer and an employee of a financial institution, the video session being rendered on a computing device of one or more customer computing devices, the virtual digital assistant obtaining the technology comfort level information from the received interactive video session, the technology comfort level information including information regarding customer preferences between different types of electronic interactions of how recommendations for the customer from the financial institution are presented and implemented when using the virtual digital assistant, including preferences of the customer for permitting or not permitting the virtual digital assistant to automatically implement one or more of the recommendations or financial advice;
receiving, from the one or more social media sites, additional information from the customer regarding the technology comfort level information, the additional information including one or more activities performed by the customer on the one or more social media sites using one or more customer computing devices;
receiving information regarding life events for the customer;
assigning a risk value to each of a plurality of recommendations;
selecting recommendations from the plurality of recommendations based on the corresponding risk value, the technology comfort level information, one or more of the life events, and knowledge gained regarding the customer from the customer financial account information; and
providing, using one of the one or more customer computing devices, the selected recommendations to the customer regarding products offered at the financial institution; and
if, based on the information regarding customer preferences, one of the selected recommendations was authorized to be automatically implemented, automatically implementing, by the server computer, the one of the selected recommendations.

15. The method of claim 14, further comprising:
determining a level of interaction between the virtual digital assistant and the customer based on the one or more of the life events and knowledge gained regarding the customer from the customer financial account information, the data regarding the customer from the one or more social media sources, the customer preferences and the technology comfort level information; and
selecting the selected recommendations to provide to the customer based on the level of interaction.

16. The method of claim 15, further comprising:
determining a trust level of the customer with the virtual digital assistant; and
determining the level of interaction based on the trust level.

17. The method of claim 15, further comprising:
identifying a customer reaction to the selected recommendations;
determining whether the customer reaction is inconsistent with the level of interaction; and
when the customer reaction is inconsistent with the level of interaction, adjusting the level of interaction to be consistent with the customer reaction.

18. (canceled)

19. The method of claim 14, further comprising:
obtaining information from the one or more social media sites regarding one or more of the life events.

20. An electronic computing device comprising:
a processing unit; and
system memory, the system memory including instructions which, when executed by the processing unit, cause the electronic computing device to:
obtain personal and financial information regarding a customer;
obtain, by a virtual digital assistant, technology comfort level information for the customer, the virtual digital assistant including a software application, the obtain including receive, by the software application, an interactive video session between the customer and an employee of a financial institution, the video session being rendered on a computing device of one or more customer computing devices, the virtual digital assistant obtaining the technology comfort level information from the received interactive video session, the technology comfort level information including information regarding preferences of the customer between different types of electronic interactions with the virtual digital assistant and regarding preferences of the customer for permitting or not permitting the virtual digital assistant to automatically implement one or more recommendations or financial advice;
obtain, from one or more social media sites, additional information regarding the technology comfort level information, the additional information including one or more activities performed on the one or more social media sites by the customer using one or more of the customer computing devices;
use the technology comfort level information to identify a level of interaction for interactions between the virtual digital assistant and the customer;
assign a risk value to each of a plurality of recommendations;
select one or more of the recommendation based on the corresponding risk value, the technology comfort level information, and the level of interaction for the virtual digital assistant with the customer;
present, using one of the one or more customer computing devices, the selected one or more recommendations to the customer;
if, based on the information regarding the preferences, one of the selected one or more recommendations was authorized to be automatically implemented, automatically implement the one of the one or more selected recommendations;
identify, using one of the one or more customer computing devices, a customer reaction to the one or more recommendations; and
when the customer reaction is inconsistent with the level of interaction, adjust the level of interaction to be consistent with the customer reaction.
